(19) United States
(12) Patent Application Publication
(10) Pub. No.: US 2015/0170798 A1
(43) Pub. Date: Jun. 18, 2015

(54) TRANSMISSION CABLE HAVING MAGNETIC ATTRACTION CAPABILITIES

(71) Applicant: CYBERPOWER SYSTEMS, INC., TAIPEI CITY (TW)

(72) Inventors: JIAN-HUNG CHEN, TAIPEI CITY (TW); CHIH-MING CHEN, TAIPEI CITY (TW)

(73) Assignee: CYBERPOWER SYSTEMS, INC., TAIPEI CITY (TW)

(21) Appl. No.: 14/105,515

(22) Filed: Dec. 13, 2013

(51) Int. Cl. H01B 7/40; H01B 7/04

(52) U.S. Cl. CPC H01B 7/40; H01B 7/04

(57) ABSTRACT

A transmission cable includes a tubular outer insulation sheath made of an electrically insulative material having magnetic substances embedded therein, and conducting wires each having an insulation axially inserted in the tubular outer insulation sheath and a metal core surrounded by the insulation. Thus, the transmission cable can be folded back and forth repeatedly to form a bundle, enabling the curved segments of the tubular outer insulation sheath to be secured to one another or a magnetically attraction wall by magnetic attraction.

### BACKGROUND OF THE INVENTION

1. Field of the Invention

The present invention relates to transmission cable technology, and more particularly to a transmission cable having magnetic attraction capabilities that can be folded back and forth repeatedly to form a bundle, enabling the curved segments of the tubular outer insulation sheath to be secured to one another or a magnetically attraction wall by magnetic attraction.

2. Description of the Related Art

With the progress of modern technology, advanced and versatile electric and electronic products have been continuously created to serve people, bringing remarkable convenience into people's lives and enhancing the comfort level and quality of life. Electric and electronic products used in our daily life or working places, such as TV, refrigerator, stereo system, washing machine, copy machine, fax machine, computer and the related peripheral apparatuses may use a power cable to collect power supply from an electric outlet or a transmission cable to transmit signal. However, when various electric and electronic apparatuses are used in a limited space area, the related cables must be well arranged. Keeping cables disorderly arranged on the floor can destroy the sense of beauty of the surroundings and cause accidents. Further, when cables are not used, people may fold the cables repeatedly back and forth into a bundle and then tie it up with an elastic band or binding wire. However, wrapping up cables tightly can break the internal metal conductors. Further, it is inconveniently to wrap up and unwrap cables.

Further, people may fasten a cable organizer to a wall or table with screws for securing a cable in an arranged condition. However, fastening a cable organizer to a wall or table with screws will damage the integrity of the wall or table. After removal of the cable organizer, ragged holes will be left and must be patched. Further, if a metal screen, rack or partition panel is used or installed in an office room, it cannot be conveniently mounted with cable organizers. Keeping cables disorderly arranged around the metal screen rack or partition panel will destroy the sense of beauty of the surroundings.

Further, keeping cables suspending from the display screen, keyboard, mouse, copy machine, scanner, fax machine or any other peripheral apparatus of a computer system can become tangled and cause the risk of accidents.

Therefore, it is desirable to find a way that facilitates the neat arrangement of cables.

### SUMMARY OF THE INVENTION

The present invention has been accomplished under the circumstances in view. It is therefore the main object of the present invention to provide a transmission cable that can be folded back and forth repeatedly to form a bundle, enabling the curved segments of the tubular outer insulation sheath to be secured to one another or a magnetically attraction wall by magnetic attraction.

To achieve this and other objects of the present invention, a transmission cable of the invention includes a tubular outer insulation sheath made of an electrically insulative material and having magnetic substances embedded therein, and conducting wires each having an insulation axially inserted in the tubular outer insulation sheath and a metal core surrounded by the insulation.

Preferably, the magnetic substances are magnetic grains or powder.

Preferably, the electrically insulative material of the tubular outer insulation sheath is selected from the group of plastics, rubber and silicon rubber.

Thus, after connection of the transmission cable to an electric outlet, electric connector or any other electric or electronic device, the excessive part of the transmission cable can be folded back and forth repeatedly to form a bundle, enabling the curved segments of the tubular outer insulation sheath to be secured to one another by magnetic attraction.

Further, the transmission cable can also be folded back and forth repeatedly to form a bundle and then secured to a magnetically attractive screen or upright partition panel by means of magnetic attraction without any binding wire or fastening means.

### BRIEF DESCRIPTION OF THE DRAWINGS

FIG. 1 is a sectional elevational view of a transmission cable in accordance with the present invention.

FIG. 2 is a schematic drawing illustrating an application example of the present invention.

FIG. 3 is a schematic drawing illustrating another application example of the present invention.

### DETAILED DESCRIPTION OF THE PREFERRED EMBODIMENT

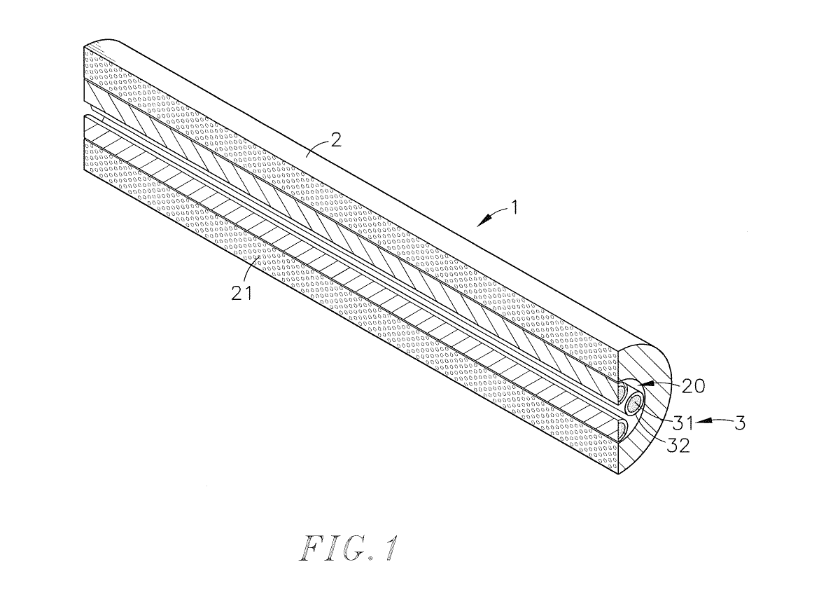

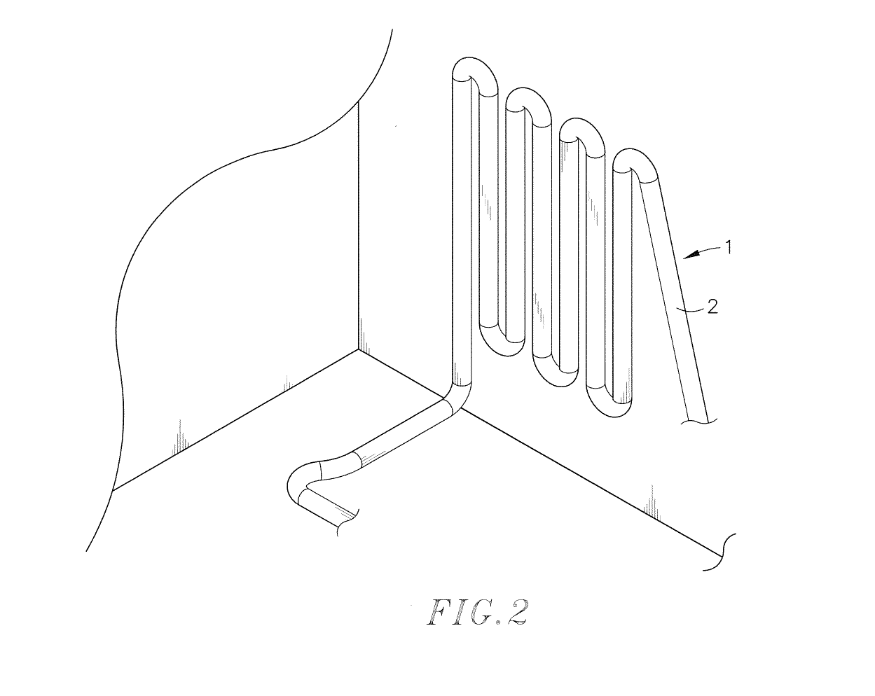

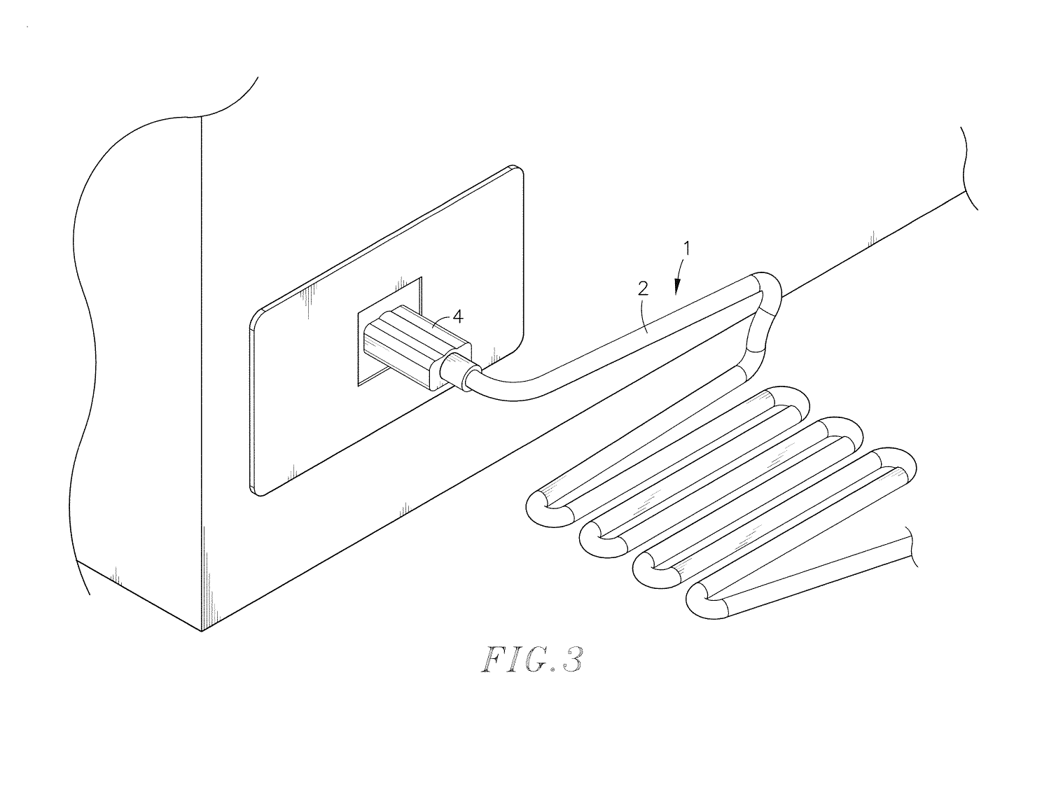

Referring to FIGS. 1-3, a transmission cable having magnetic attraction capabilities in accordance with the present invention is shown. The transmission cable, referenced by 1, comprises a tubular outer insulation sheath 2, and at least one, for example, a plurality of conducting wires 3 surrounded by the tubular outer insulation sheath 2.

The tubular outer insulation sheath 2 is made of an electrically insulative material having magnetic substances 21 embedded therein. Further, the tubular outer insulation sheath 2 defines therein an axially extending tubular accommodation space 20. Further, the magnetic substances 21 can be magnetic grains or powder.

Each conducting wire 3 comprises a metal core 31 for signal transmission, and an insulation 32 surrounding the metal core 31. During installation, the conducting wires 3 are inserted into the tubular accommodation space 20 in the tubular outer insulation sheath 2. Thus, the metal cores 31 of the conducting wires 3 are isolated from the tubular outer insulation sheath 2 by the insulation 32 and.

Further, the tubular outer insulation sheath 2 can be made of plastics, rubber, or silicon rubber. Further, the magnetic substances 21 are evenly distributed in the tubular outer insulation sheath 2, enabling the tubular outer insulation sheath 2 to have magnetic attraction capabilities. Further, the metal core 31 of each conducting wires 3 can be formed of a single piece of metal wire, or twisted metal wires for transmitting electronic signal, data signal or power signal. Under the protection and isolation effects of the insulation 32, the metal core 31 is kept from the interference of the magnetic substances 21, assuring a high level of signal transmission stability and reliability.

During an application to connect the transmission cable 1 to an electric outlet 4, electric connector or any other electric or electronic device, the excessive part of the transmission cable 1 can be folded back and forth repeatedly to form a bundle, enabling the curved segments of the tubular outer insulation sheath 2 to be secured to one another by the effect of magnetic attraction of the magnetic substances 21. Thus, the transmission cable 1 can be neatly installed, saving installation space and reducing tangles and the risk of damage caused by accidental stretching. Further, when the transmission cable 1 is not used, it can also be folded back and forth repeatedly and secured in the neatly arranged condition by magnetic attraction.

Further, the transmission cable 1 can also be folded back and forth repeatedly to form a bundle and then secured to a magnetically attractive screen or upright partition panel by means of magnetic attraction without any binding wire or fastening means, avoiding damage to the magnetically attractive screen or upright partition panel, saving floor space, facilitating storage and keeping the arranged transmission cable 1 in place.

In conclusion, the invention provides transmission cable having magnetic attraction capabilities that comprises a tubular outer insulation sheath 2 made of an electrically insulative material having magnetic substances 21 embedded therein and defining therein an axially extending tubular accommodation space 20, and at least one conducting wire 3 inserted into the tubular accommodation space 20 in the tubular outer insulation sheath 2 and having a metal core 31 for signal transmission and an insulation 32 surrounding the metal core 31 for protection. Thus, if the transmission cable 1 is installed in an electric outlet or any electric or electronic device or if the transmission cable 1 is not used, the transmission cable 1, either wholly or partially, can be folded back and forth repeatedly to form a bundle, enabling the curved segments of the tubular outer insulation sheath 2 to be secured to one another by the effect of magnetic attraction of the magnetic substances 21 to reduce space occupation. Further, after having been repeatedly folded back and forth, the transmission cable 1 can be secured to a magnetically attractive screen or upright partition panel by means of magnetic attraction without any binding wire or fastening means, avoiding damage to the magnetically attractive screen or upright partition panel, saving floor space, facilitating storage and keeping the arranged transmission cable in place.

Although a particular embodiment of the invention has been described in detail for purposes of illustration, various modifications and enhancements may be made without departing from the spirit and scope of the invention. Accordingly, the invention is not to be limited except as by the appended claims.

1. A transmission cable, comprising:
a tubular outer insulation sheath made of an electrically insulative material having magnetic substances embedded and evenly distributed therein, said tubular outer insulation sheath defining therein an axially extending tubular accommodation space; and
at least one conducting wire inserted into said tubular accommodation space in said tubular outer insulation sheath, each said conducting wire comprising a metal core for signal transmission and an insulation surrounding said metal core.

2. The transmission cable as claimed in claim 1, wherein said magnetic substances are magnetic grains or powder.

3. The transmission cable as claimed in claim 1, wherein said electrically insulative material of said tubular outer insulation sheath is selected from the group of plastics, rubber and silicon rubber.
